(19) United States
(12) Patent Application Publication
(10) Pub. No.: US 2023/0074165 A1
(43) Pub. Date: Mar. 9, 2023

(54) Electrochemical Dechlorination of Chloraminated Water and Wastewater Effluent

(71) Applicant: The Board of Trustees of the Leland Stanford Junior University, Stanford, CA (US)

(72) Inventors: William Mitch, Menlo Park, CA (US); Cindy Weng, Menlo Park, CA (US)

(21) Appl. No.: 17/891,773

(22) Filed: Aug. 19, 2022

Related U.S. Application Data
(60) Provisional application No. 63/236,025, filed on Aug. 23, 2021.

(51) Int. Cl. C02F 1/467

(52) U.S. Cl. CPC C02F 1/4676; C02F 2101/12

(57) ABSTRACT

An electrochemical dechlorination of water method is provided. Dechlorination of water, containing chlorine or chloramine, is performed in an electrochemical reactor by passing electrons directly from an electrical grid to the chlorine or the chloramine via a cathode, where the dechlorination for the chlorine is defined by HOCl+2e⁻→Cl⁻+OH³¹, and wherein the dechlorination for the chloramine is defined by NH₂Cl+H⁺+2e⁻→Cl⁻+NH₃. The cathode can be a stainless steel cathode. In one variation, the cathode and the anode are separated by a cation-exchange membrane. By means of this method, wastewater can be dechlorinated using power from the electric grid without the addition of external chemicals, thereby avoiding the cost of the chemicals, their transport, and the presence of their degradation products in the effluent water.

### CROSS-REFERENCE TO RELATED APPLICATIONS

This application claims priority from U.S. Provisional Patent Application 63/236,025 filed Aug. 23, 2021, which is incorporated herein by reference.

### FIELD OF THE INVENTION

This invention relates in general to dechlorination of water.

### BACKGROUND OF THE INVENTION

Chlorine is the most common disinfectant applied to municipal wastewater effluents. Because most municipal wastewater plants do not practice nitrification, the applied chlorine (˜0.2 mM) reacts rapidly with the substantial ammonia concentrations in these waters (˜2 mM)² to form monochloramine (NH₂Cl) as the dominant disinfectant species. After disinfection, utilities typically add sodium bisulfite (NaHSO₃) to degrade the residual disinfectants (equation 1) and prevent mortality of aquatic organisms when the effluent is discharged to receiving waters.

HSO₃⁻NH₂Cl+H₂O→Cl⁻NH₄⁺+SO₄²⁻+H⁺ (1)

Although effective, dechlorination using bisulfite (HSO₃⁻) features several drawbacks, including the cost of purchasing and shipping NaHSO₃, and the CO₂ emissions associated with transport of NaHSO₃ to the site. Moreover, discharge of the sulfate produced as a byproduct of bisulfite dechlorination (equation 1) can increase the total dissolved solids (TDS) in the receiving water, reducing the quality of the receiving water as a source water for downstream drinking water utilities.

### SUMMARY OF THE INVENTION

The use of sodium bisulfite as an electron donor to quench chloramine disinfectant residuals in municipal wastewater effluents prior to discharge incurs the cost of purchasing and transporting bisulfite to the utility and increases the loading of salts to the receiving water. In one embodiment, the inventors quenched chloramine residuals within a reductive electrochemical reactor, which supplied electrons via a stainless steel cathode. Under potentiostatic conditions, electrochemical dechlorination rates were maximized at −1.17 V vs. Standard Hydrogen Electrode (SHE), where 40 μM chloramines (2.8 mg/L as Cl₂) were converted to ammonia and chloride within 25 min. Dechlorination rates increased as the specific surface area of the stainless steel electrodes increased, and were higher for 201-grade stainless steel than other grades of stainless steel. Dechlorination rates were similar across pH (5.6-8.7) and ionic strength (0.9-12.4 mM) conditions relevant to wastewater. Dechlorination rates on a comparable electrode surface area to water volume basis were not affected by the removal of an ion exchange membrane separating anode and cathode chambers. Under galvanostatic conditions (50 mA), quenching of chloramines in authentic secondary effluents was achieved within ˜3 minutes. Operational cost estimates indicated that electrochemical dechlorination may be a competitive alternative to bisulfite, particularly in locations where electricity costs are low. Further optimization of the electrode and reactor design could reduce the electricity cost and facilitate scale-up.

In another embodiment, the inventors provide a method of electrochemical dechlorination of water. Dechlorination of water, containing chlorine or chloramine, in an electrochemical reactor with a cathode and an anode, is performed by passing electrons directly from an electrical grid to the chlorine or the chloramine via the cathode, where the dechlorination for the chlorine is defined by HOCl+2e⁻→Cl⁻+OH⁻, and wherein the dechlorination for the chloramine is defined by NH₂Cl+H⁺+2e⁻→Cl⁻+NH₃. The cathode can be a stainless steel cathode. In one variation, the cathode and the anode are separated by a cation-exchange membrane.

The primary advantage of the embodiment is that wastewater can be dechlorinated using power from the electric grid without the addition of external chemicals, thereby avoiding the cost of the chemicals, their transport, and the presence of their degradation products in the effluent water.

### BRIEF DESCRIPTION OF THE DRAWINGS

FIG. 1 shows according to an exemplary embodiment of the invention an electrochemical reactor for dichlorination. Dechlorinating the water is established by passing electrodes directly from an electrical grid to the chlorine or the chloramine via a cathode, where the dechlorination for chlorine is defined by HOCl+2e⁻→Cl⁻+OH⁻, and where the dechlorination for chloramine is defined by NH₂Cl+H⁺2e⁻→Cl⁻+NH₃.

FIG. 2 shows according to an exemplary embodiment of the invention an electrochemical reactor for dechlorination including an ion exchange membrane. Dechlorinating the water is established by passing electrons directly from an electrical grid to the chlorine or the chloramine via a cathode, where the dechlorination for chlorine is defined by HOCl+2e⁻→Cl⁻+OH⁻, and where the dechlorination for chloramine is defined by NH₂Cl+H⁺2e⁻→Cl⁻+NH₃.

FIG. 3 shows according to an exemplary embodiment of the invention an electrochemical reactor structure. Determination of uncompensated resistance. Potentiometric Electrochemical Impedance Spectroscopy (PEIS) was used to measure the uncompensated resistance. For the 7 mM phosphate buffer solution, the open cell potential was −0.23 V. The uncompensated resistance, measured as the first x-intercept in the Nyquist plot (FIG. 10), was 7.25 Ω2. The typical current for experiments involving application of −1.17 V/SHE to the cathode was ˜20 mA, such that the voltage associated with the uncompensated resistance was ˜0.14 V. The voltages applied to the cathode are reported as V/SHE without correction for uncompensated resistance.

FIGS. 4A-C show according to an exemplary embodiment of the invention degradation of 40 μM NH₂Cl (2.85 mg/L as Cl₂) in deionized water with 7 mM phosphate buffer using 304-grade stainless steel plates as anode and cathode. (FIG. 4A) Degradation over time with and without a cation exchange (IX) membrane separating the anode and cathode chambers during application of −1.17 V/SHE to the cathode. The data without the IX membrane are also plotted after normalizing by the two-fold increase in solution volume, which resulted from the removal of the IX membrane. Error bars represent the range of experimental duplicates. (FIG. 4B) Observed pseudo-first order degradation rate constants (k_{obs}, s⁻¹) for different voltages applied to the cathode with an IX membrane. Error bars represent the standard error on the slope of the regression. (FIG. 4C) Percent removal of NH₂Cl after 25 min of treatment with an IX membrane for different voltages applied to the cathode. Error bars represent the range of experimental duplicates.

FIG. 5 shows according to an exemplary embodiment of the invention degradation of 100 μM NH₂Cl (7.1 mg/L as Cl₂) using 304-grade stainless steel plates as the anode and cathode without a cation exchange membrane in deionized water buffered with 7 mM phosphate at pH 5.6, 7.0, and 8.7 during application of −1.17 V/SHE as a function of time. Error bars represent the range of experimental duplicates.

FIG. 6 shows according to an exemplary embodiment of the invention degradation of 40 μM NH₂Cl (2.85 mg/L as Cl₂) vs. time for different ionic strength (IS) solutions at pH 7 when −1.17 V/SHE was applied to the cathode using 304-grade stainless steel plates as anode and cathode without an ion exchange membrane. Ionic strengths included 12.4 mM (7 mM phosphate buffer), 0.92 mM (1 mM NaHCO₃), 2.9 mM (1 mM NaHCO₃ and 2 mM NaCl) and 4.9 mM (1 mM NaHCO₃ and 4 mM NaCl). Error bars represent the range of experimental duplicates.

FIG. 7 shows according to an exemplary embodiment of the invention degradation of 40 μM NH₂Cl in 7 mM phosphate buffer at pH 7 when −1.17 V/SHE was applied to the cathode without an ion exchange membrane. Electrodes have different masses of 410-grade stainless steel scrubbers that corresponded to different electrode surface areas normalized to the 85 mL volume of electrolyte (1.5-5.6 cm²/cm³). Results from the use of 304-grade stainless steel plate electrodes (39.2 cm² or 0.5 cm²/cm³) are shown for comparison. Error bars represent the range of experimental duplicates.

FIG. 8 shows according to an exemplary embodiment of the invention degradation of 40 μM NH₂Cl in 7 mM phosphate buffer at pH 7 vs. time for different grades of stainless steel anodes and cathodes when −1.17 V/SHE was applied to the cathode without a cation exchange membrane. The surface areas for each electrode were 39.2 cm² for the 201, 304 and 430 grades of stainless steel plate electrodes and 128 cm² for the 410 grade stainless steel scrubber electrodes. Error bars represent the range of experimental duplicates. The control represents 304 SS with no applied voltage over time.

FIG. 9 shows according to an exemplary embodiment of the invention degradation of NH₂Cl vs. time within a nitrified (Plant 1; 50 μM NH₂Cl) and a non-nitrified municipal wastewater effluent (Plant 2; 34 μM NH₂Cl) using 410-grade stainless steel scrubber electrodes (3.9 g or 312 cm²) without an ion exchange membrane under galvanostatic conditions (50 mA). Error bars represent the standard error of four experimental replicates.

FIG. 10 shows according to an exemplary embodiment of the invention a Nyquist plot (real impedance, Re(Z), in Ohms vs. imaginary impedance, -Im(Z), in Ohms). The uncompensated resistance was measured using 7 mM phosphate buffer at pH 7 as anolyte and catholyte with the 304-grade stainless steel plate electrodes.

FIG. 11 shows according to an exemplary embodiment of the invention a plot of ln(C/C₀) vs. time of data from FIG. 4A to illustrate that NH₂Cl degradation followed first-order kinetics. The experiment involved application of −1.17 V/SHE to the cathode with the cathode and anode chambers separated by a cation exchange membrane. Both catholyte and anolyte have 7 mM phosphate buffer in deionized water adjusted to pH 7 but only the catholyte contained 40 μM NH₂Cl. The data from duplicate experiments were pooled and used for regression analysis.

FIG. 12 shows according to an exemplary embodiment of the invention degradation of 40 μM NH₂Cl (2.85 mg/L as Cl₂) as a function of voltage applied to the cathode in deionized water with 7 mM phosphate buffer using 304-grade stainless steel plates as anode and cathode separated by a cation exchange membrane. Error bars represent the range of experimental duplicates.

FIG. 13 shows according to an exemplary embodiment of the invention degradation of 40 μM NH₂Cl (2.85 mg/L as Cl₂) in deionized water with 7 mM phosphate buffer using 304-grade stainless steel plates as anode and cathode with and without a cation exchange membrane. To normalize for the doubling of the volume of water that was treated resulting from the removal of the ion exchange membrane, chloramine concentrations are plotted against time multiplied by the specific surface area (SSA; i.e., surface area of the cathode divided by the volume of water treated). Error bars represent the range of experimental duplicates.

FIG. 14 shows according to an exemplary embodiment of the invention degradation of 40 μM NH₂Cl (2.85 mg/L as Cl₂) as a function of voltage applied to the cathode in deionized water with 7 mM phosphate buffer using (A) 201-grade or (B) 430-grade stainless steel plates as anode and cathode separated by a cation exchange membrane. Error bars represent the range of experimental duplicates.

### DETAILED DESCRIPTION

Electrochemical treatment systems can be attractive for water and wastewater treatment due to their potential to avoid the purchase and transportation of chemical reagents. However, they have rarely been implemented at full-scale. Research on environmental applications of electrochemical treatment systems has focused on oxidative (anodic) processes for the degradation of contaminants occurring at low concentrations. Challenges for such anodic applications include (1) the use of expensive anode materials (e.g., boron-doped diamond), (2) low efficiencies that result from high concentration constituents (e.g., natural organic matter) outcompeting target organics for reaction at anode surfaces, and (3) production of undesirable oxidation products (e.g., chlorate and trihalomethanes) from oxidation of chloride. Electrochemical systems using inexpensive electrode materials to target reduction of constituents that occur at significant concentrations (>1 μM) may prevent these challenges.

For dechlorination of wastewater, HSO₃⁻ serves ultimately as a source of electrons for the reduction of NH₂Cl to produce ammonium (NH₄+) and chloride (Cl⁻) as harmless byproducts (equation 1). Electrochemical reduction could achieve dechlorination by passing electrons directly from the electric grid to NH₂Cl via a cathode (equation 2), thereby avoiding the cost and CO₂ emissions associated with purchase and transport of NaHSO₃ and minimizing the increase in TDS in receiving waters associated with discharge of municipal wastewater effluents. Research on the electrochemical reduction of NH₂Cl has been limited to the use of cyclic voltammetry to determine that NH₂Cl reduction using different electrode materials occurs at +0.05 V vs. Standard Hydrogen Electrode (V/SHE) for poly(3,4-ethylenedioxythiophene) (PEDOT) electrodes, +0.08 V/SHE for platinum electrodes, and +0.24 V/SHE for gold electrodes. To the best of the inventors' knowledge, research has not evaluated electrochemical reduction of NH₂Cl as a method of wastewater dechlorination.

2e⁻+NH₂Cl+2H⁺→Cl⁻+NH₄⁺ (2)

In this invention, the inventors assessed the potential of electrochemical reduction as an alternative to bisulfite reduction for dechlorination of municipal wastewater effluent. The objective was to determine whether electrochemical dechlorination of municipal wastewater could be accomplished over timescales (<1 h) feasible for full-scale wastewater treatment using stainless steel as a low-cost material for cathode construction. In addition to assessing the effect of electrochemical treatment conditions (e.g., voltage, ionic strength, stainless steel materials) on NH₂Cl dechlorination, the work evaluated dechlorination within authentic chloraminated municipal wastewater effluents. First the experimental work and methods are described.

Materials

Sodium hypochlorite (NaOCl, ˜5%), ammonium chloride (NH₄Cl), sodium phosphate dibasic anhydrous (Na₂HPO₄), and sodium phosphate monobasic monohydrate (NaH₂PO₄) were purchased from Fisher Scientific (Hampton, N.H.).

Potassium phosphate monobasic was purchased from Sigma Aldrich (St. Louis, Mo.). Potassium iodide was purchased from Acros Organics (Geel, Belgium). Ammonia kits (TNT830, low-range) and N,N-diethyl-p-phenylenediamine, oxalic acid salts (DPD oxalate) were purchased from Hach Company (Loveland, Colo.).

Stock hypochlorite solutions in deionized water were standardized using a Cary 60 UV-visible spectrophotometer by UV absorbance at 292 nm (ε₂₉₂ₙₘ=365 M⁻¹ cm⁻¹). Monochloramine stock solutions (20 mM) were prepared daily by adding one drop of sodium hypochlorite at a time to a well-mixed ammonium chloride solution at a 1:1.2 molar ratio. Stock solutions were periodically standardized by measuring the UV absorbance at the absorption maxima of monochloramine (245 nm) and dichloramine (295 nm) to validate that dichloramine constituted <5% of total chloramines. The total chlorine residual in samples collected from the reactor was measured using the DPD colorimetric method¹¹ after diluting samples five-fold in deionized water.

Grab samples of secondary municipal wastewater effluent were collected at two treatment facilities. At Plant 1, the nitrified secondary effluent sample was collected after additional treatment by microfiltration at the facility. Although the wastewater was fully nitrified, a small chloramine residual (˜2 mg/L as Cl₂) was added to the wastewater upstream of microfiltration, but the residual had dissipated prior to the use of this wastewater in experiments, resulting in a small, but measurable ammonia concentration. At Plant 2, a non-nitrified secondary effluent sample was collected prior to disinfectant addition. Table 1 provides basic water quality information for the two samples.

Electrochemical Treatment

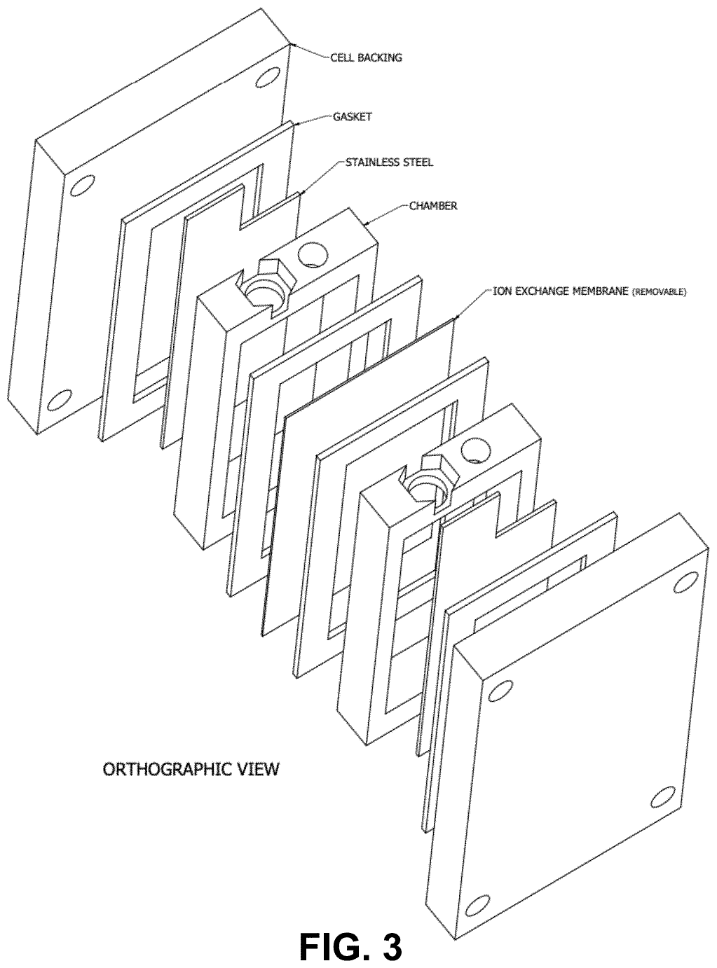

The electrochemical treatment system has a rectangular chamber (8 cm long×3.5 cm wide×3.75 cm deep) produced by a 3D printer (ELEGOO, Shenzhen, China) using a photopolymer resin (ELEGOO, Shenzhen, China). Unless otherwise stated, the reactor was split into anode and cathode chambers (42.5 mL each) using a cation exchange membrane (Ultrex CMI-7000, Membranes International, Ringwood, N.J.). Two flat-plate electrodes (8 cm×3.5 cm) constructed from perforated stainless steel sheets (304 grade, 0.061 cm thickness, 0.16 cm diameter, and staggered holes with a 0.28 cm center-to-center distance; McMaster-Carr, catalog number 9358T11) were placed in the anode and cathode chambers separated by 3 cm. To evaluate the effect of different grades of stainless steel, some experiments used 201 and 430 grade stainless steel perforated sheets with the same dimensions and hole patterns (Boegger Industech Limited, Anping, Hebei, China); Table 2 provides the elemental composition of the different grades of stainless steel. The overall stainless steel surface area for each of these stainless steel electrodes was 39.2 cm², accounting for the holes and both sides of each plate. To evaluate the effect of electrode surface area, additional experiments employed ScotchBrite 20 g stainless steel scrubbers (410 grade stainless steel; 80 cm²/g specific surface area; catalogue number 214C, 3M Company, St. Paul, Minn., USA) cut to different sizes to serve as cathodes. The reactor components were joined using chemical-resistant fluoroelastomer gaskets (McMaster-Carr, catalogue number 9473K63). FIG. 3 provides a schematic for this reactor.

Prior to each experiment, the reactor chamber was rinsed three times with deionized water. For many experiments, the anode and cathode chambers were filled with deionized water buffered with 7 mM monopotassium phosphate. This buffer concentration approximates the ionic strength of municipal wastewater. For example, 7 mM NaCl would equal a total dissolved solids (TDS) concentration of 400 mg/L. Other experiments evaluated the effect of solution conditions (e.g., pH, electrolyte constitution) and treatment of municipal wastewater. Anolyte and catholyte were stirred throughout the treatment using Teflon-coated magnetic stir bars. A saturated Ag/AgCl reference electrode (CHI111P, porous Teflon tip, CH Instruments, Austin, Tex.) was placed 0.25 cm from the cathode, and the porous frit prevented direct contact with the electrode. A portion of each electrode extended above the reactor for attachment of potentiostat leads without contact with the solution (FIG. 3). A CH600D potentiostat (CH Instruments, Austin, Tex.) was used either to apply constant potentials to the cathode or to operate in galvanostatic mode. Potentiometric electrochemical impedance spectroscopy was used to measure the uncompensated resistance for a 7 mM phosphate buffer solution as 7.25Ω (see legend FIG. 3). Because the currents measured during typical experiments were low (˜20 mA), the potentials applied to the cathode are reported vs. Standard Hydrogen Electrode (V/SHE) without correction for the uncompensated resistance.

Results

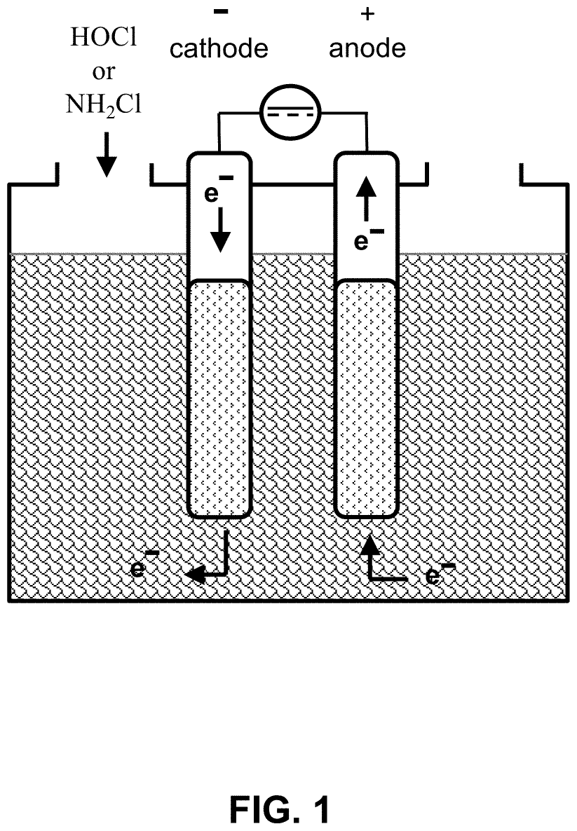

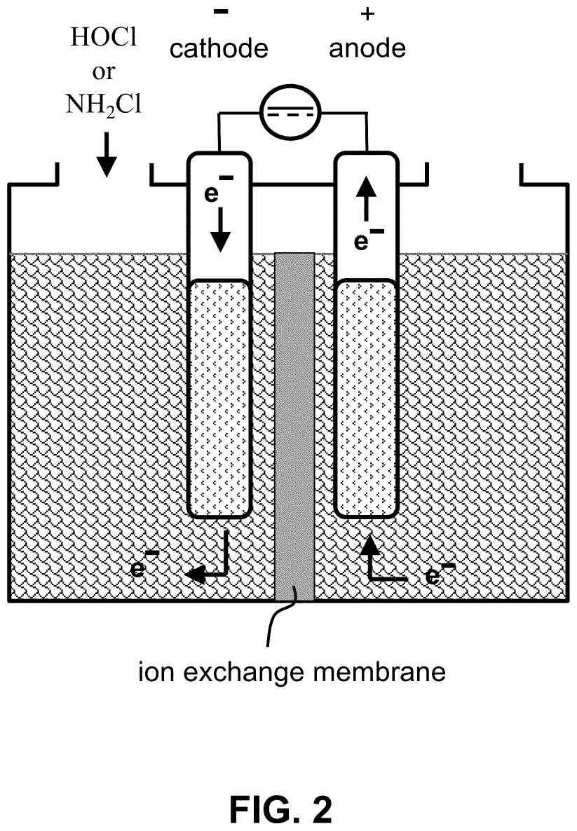

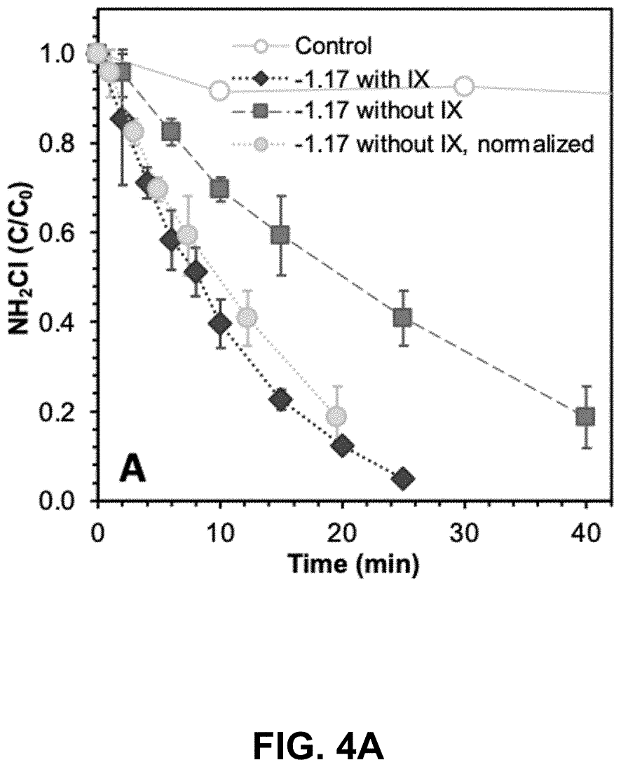

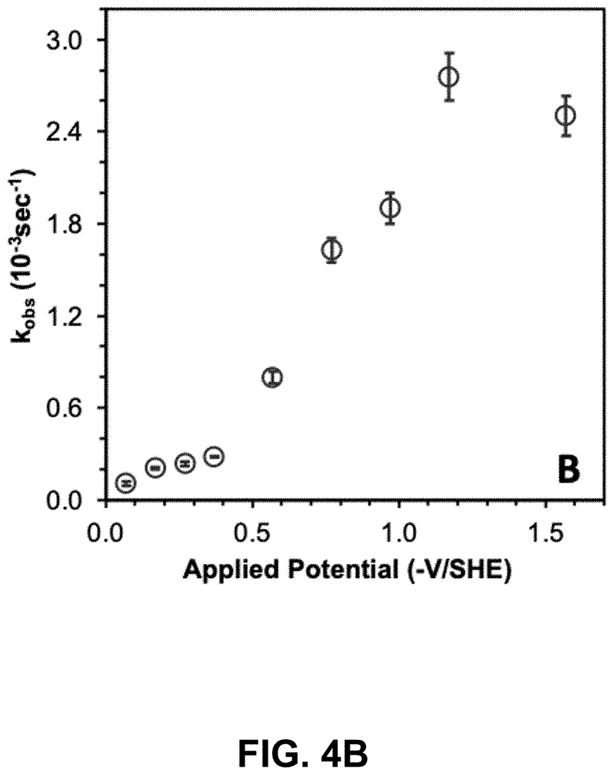

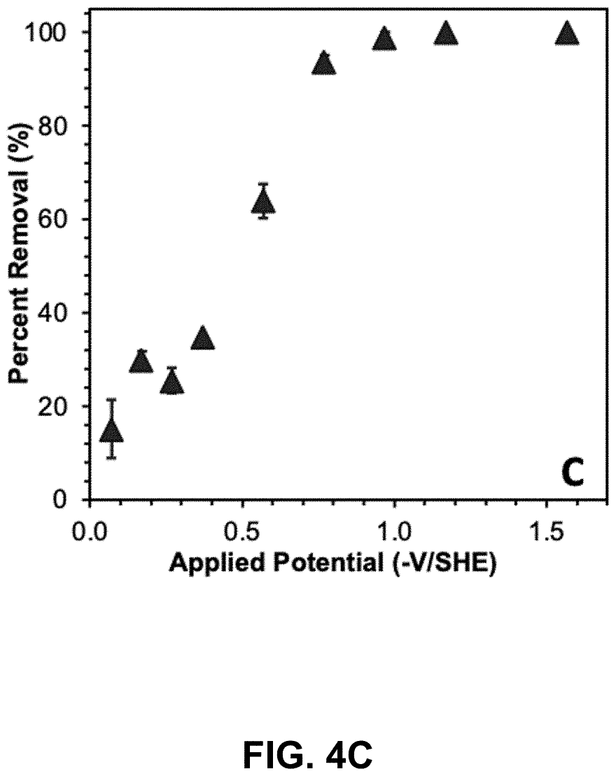

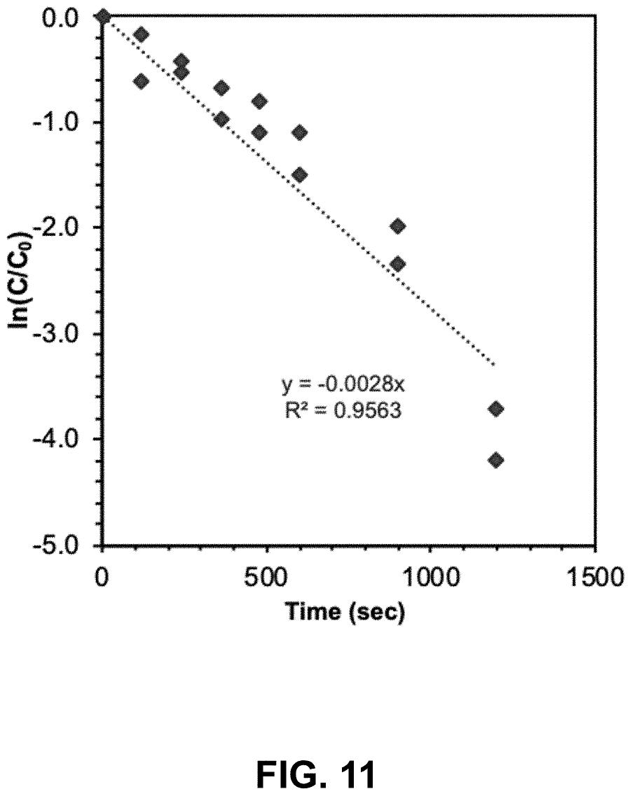

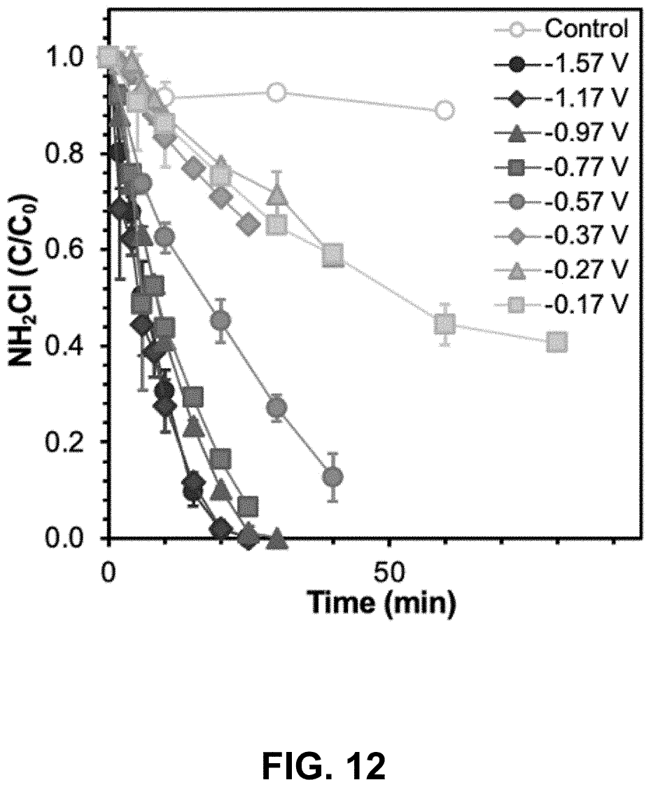

Effect of applied voltage and presence or absence of an ion exchange membrane. Initial experiments involved separation of the anode and cathode by a cation exchange (IX) membrane with both catholyte and anolyte having deionized water containing 7 mM phosphate buffer adjusted to pH 7, but only the catholyte containing 40 μM NH₂Cl (2.85 mg/L as Cl₂). In a control involving no application of a voltage to the cathode, <10% degradation of NH₂Cl was observed (FIG. 4A). When −1.17 V/SHE was applied to the cathode, degradation of NH₂Cl was 80% within 15 min and ˜100% within 25 min (FIG. 1A). A plot of ln(C/C₀) vs. time confirmed that NH₂Cl degradation followed first-order kinetics (FIG. 11). FIG. 4B provides the pseudo-first order NH₂Cl degradation rate constants (k_{obs}) measured when this experiment was repeated for voltages applied to the cathode ranging from −0.17 V/SHE to −1.57 V/SHE, while FIG. 4C provides the percentage degradation of NH₂Cl after 25 min for the same series of experiments; FIG. 12 provides the associated time series plots. The degradation rates increased as the applied potential decreased from −0.17 V/SHE to −1.17 V/SHE, but then leveled out. After 25 min, the pH of the anolyte had decreased to ˜6 while the pH of the catholyte had increased to ˜11 when −1.17 V/SHE was applied to the cathode. Proton consumption within the catholyte (equation 2) would increase pH, while oxidation of water in the anolyte would decrease pH (equation 3).

2H₂O→4H⁺+O₂+4e⁻ (3)

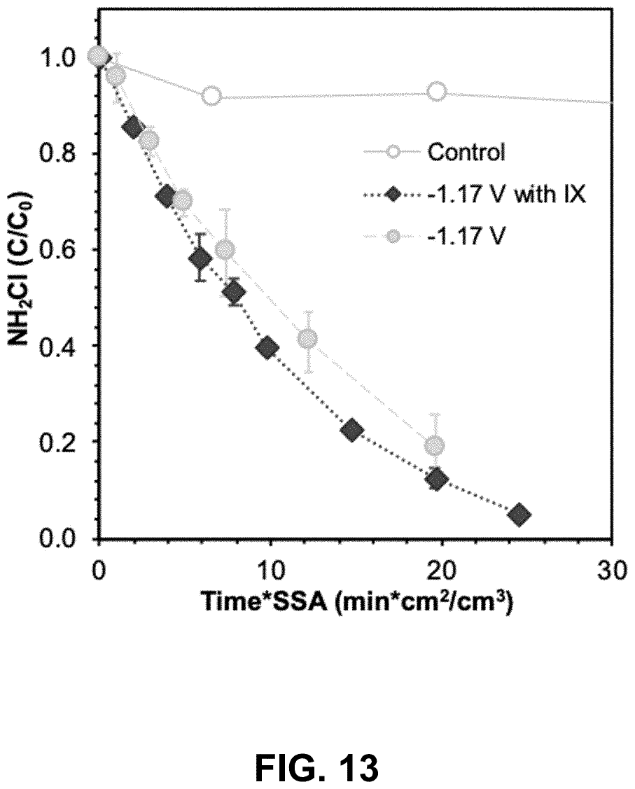

The cation exchange membrane prevents the oxidation of chloride to undesirable oxidation byproducts by blocking transport of chloride from the catholyte to the anolyte. However, in addition to producing a pH gradient across the membrane, the ion exchange membrane complicates the scale-up for electrochemical systems. The removal of the cation exchange membrane converts what were originally separate anode and cathode compartments into a single chamber. The experiment involving application of −1.17 V/SHE to the cathode was repeated without the cation exchange membrane using an electrolyte that has deionized water containing 40 μM NH₂Cl buffered with 7 mM phosphate buffer throughout this single chamber. The pH of the electrolyte remained at 7 throughout the reaction. The timescale for NH₂Cl degradation increased (FIG. 4A), reflecting the doubling of the volume of NH₂Cl solution being treated, such that the ratio of the cathode surface area to the volume of solution was halved. Given the doubling of the treated electrolyte volume, the results from this experiment were normalized by reducing the time associated with each datapoint in half to compare against the experiment with the cation exchange membrane (circles in FIG. 4A); FIG. 13 provides an alternative plot against time normalized by the specific surface area (i.e., cathode area divided by the volume of water). The results indicate a close match with the results observed in the presence of the IX membrane (FIG. 4A). These results suggest that the nature of the reactions with and without the IX membrane were the same, but that the decrease in the observed kinetics of NH₂Cl degradation resulted predominantly from the decrease in the ratio of cathode surface area to electrolyte when removal of the ion exchange membrane doubled the volume of solution treated by the cathode.

Reaction products: The inventors hypothesized that reduction via a two-electron transfer to NH₂Cl would produce NH₄⁺ and Cl⁻ (equation 2). However, several other reaction pathways could form NO₂⁻, NO₃⁻ and/or chlorinated byproducts, including chlorite (ClO₂⁻) and chlorate (ClO₃⁻). For example, a one-electron reduction at the cathode could form NH₂^{•} and Cl⁻ (equation 4). NH₂^{•} rapidly reacts with dissolved oxygen (1.2×10⁸ M⁻¹ s⁻¹) to form NH₂OO^{•} (equation 5), which decays to form NO^{•} and ultimately to NO₂⁻ and NO₃⁻ via a series of subsequent steps (equations 6-9).¹²⁻¹⁴ Oxidation of NH₄⁺ at the anode could also form NO₂⁻ and NO₃⁻. Oxidation of Cl⁻ at the anode could form HOCl (equation 10), which could react with NH₄⁺ to reform NH₂Cl (equation 11). Alternatively, oxidation of OCl⁻ could form chlorite (ClO₂⁻) and chlorate (ClO₃⁻) via a ^{•} OCl intermediate (equation 12).¹⁵

NH₂Cl+e⁻→NH₂^{•}+Cl⁻ (4)

NH₂^{•}+O₂→NH₂OO^{•} (5)

NH₂OO^{•}→NO^{•}+H₂O (6)

2NO^{•}+O₂→2NO₂ (7)

2NO₂^{•}→N₂O₄ (8)

N₂O₄+H₂O→NO₂⁻+NO₃⁻+H₂O (9)

Cl⁻+H₂O→HOCl+2e⁻+H⁺ (10)

HOCl+NH₄⁺→NH₂Cl+H₂O+H⁺ (11)

OCl⁻→^{•}OCl+e⁻→→ClO₂⁻→→ClO₃⁻ (12)

To characterize reaction products, the experiment without the ion exchange membrane (−1.17 V/SHE) was repeated with 100 μM NH₂Cl for 2 h, after which no measurable residual chloramines were detected. The ammonia measured after the experiment accounted for 83% (±3% range of experimental duplicates) of the 120 μM total ammonia in the initial NH₂Cl solution, indicating that ammonia was the predominant product. Nitrite and nitrate concentrations were <2 μM, such that they could account for <4% of the total ammonia. A control without application of a potential to the electrodes indicated 10% loss of NH₂Cl over 2 h, likely due to volatilization. These results indicate that NH₄⁺ production by the two-electron reduction (equation 2) was favored over NH₂^{•} formation by the one-electron reduction pathway (equation 4), and that NH₄⁺ oxidation to NO₂ and NO₃ at the anode was negligible. Moreover, ClO₂⁻ and ClO₃⁻ were not detectable (<1 μM).

To further evaluate the potential for Cl oxidation at the anode, the experiment without the ion exchange membrane (−1.17 V/SHE) was repeated for 40 min with either 1) 500 μM NH₄Cl in 7 mM phosphate buffer, or 2) with 1 mM NaHCO₃ and 2 mM NaCl (representing salt levels in source waters). In neither case were chlorine or chloramine residuals, ClO₂⁻ or ClO₃⁻ detected, indicating that Cl oxidation at the anode was not significant.

Effect of Reaction Conditions and Electrode Design

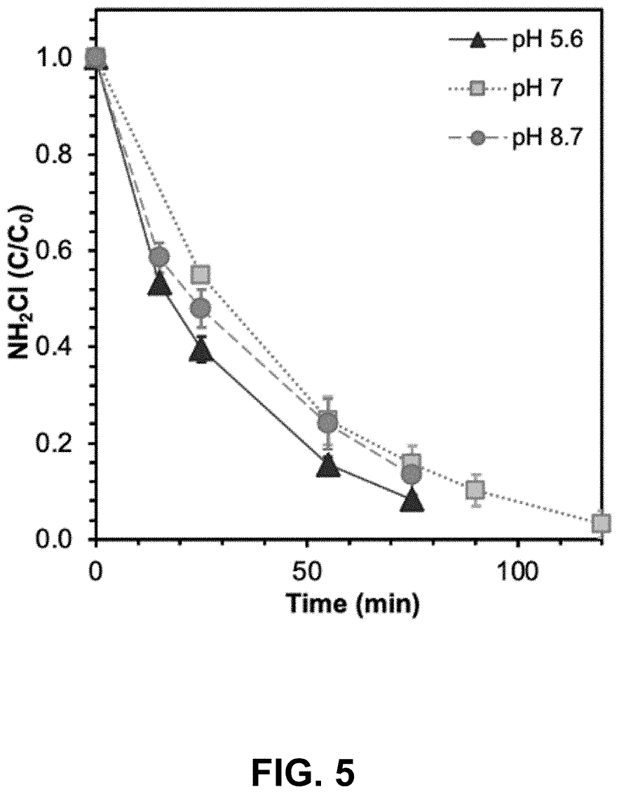

NH₂Cl occurs in equilibrium with dichloramine (NHCl₂; equation 13). NHCl₂ is a minor species (<10%) at pH≥7, but becomes dominant at lower pH. For initial pH values of 5.6, 7.0, and 8.7, the pH changed by <10% over 75 min during experiments involving application of −1.17 V/SHE to the cathode using 304-grade stainless steel plates as anode and cathode without an ion exchange membrane to treat the 100 μM NH₂Cl added to the 7 mM phosphate. The degradation of chloramines was similar over these three pH values (FIG. 5), indicating that pH and inorganic chloramine speciation do not significantly affect electrochemical reduction of inorganic chloramines.

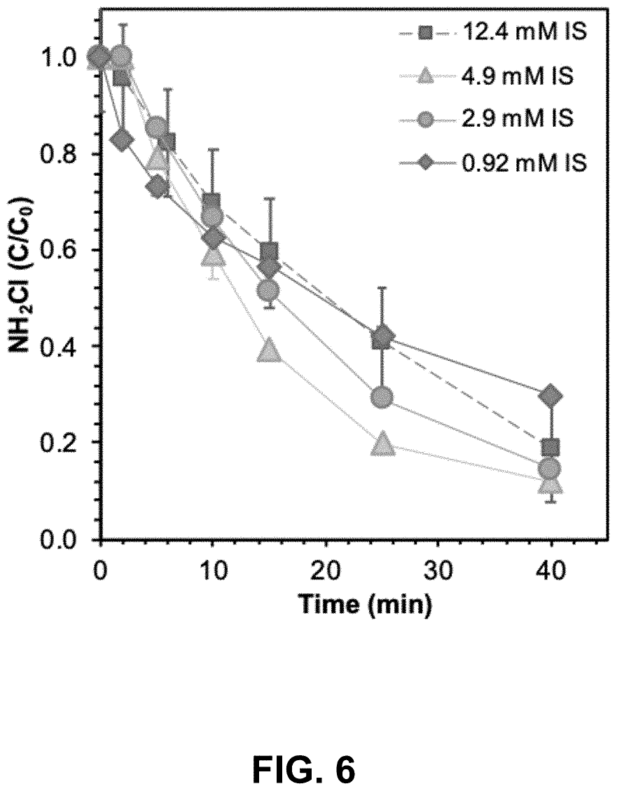

Increasing ionic strength can promote electrochemical reactions by reducing the solution resistance. The ionic strength of 7 mM phosphate buffer at pH 7 is 12.4 mM. To evaluate the impact of ionic strength, decay of 40 μM NH₂Cl without an ion exchange membrane in deionized water at pH 7 containing (1) 1 mM NaHCO₃ (0.92 mM ionic strength) was also evaluated, (2) 1 mM NaHCO₃ with 2 mM NaCl (2.9 mM ionic strength), and (3) 1 mM NaHCO₃ with 4 mM NaCl (4.9 mM ionic strength). The NaHCO₃ and NaCl concentrations were selected to encompass NaHCO₃ buffer concentrations and NaCl concentrations characteristic of natural waters and wastewaters; for example, 4 mM NaCl represents 232 mg/L total dissolved solids (TDS). The results do not demonstrate a strong dependence on ionic strength (FIG. 6). Degradation after 40 min was ≥80% for ionic strength ≥2.9 mM, but still ˜70% for 0.92 mM ionic strength.

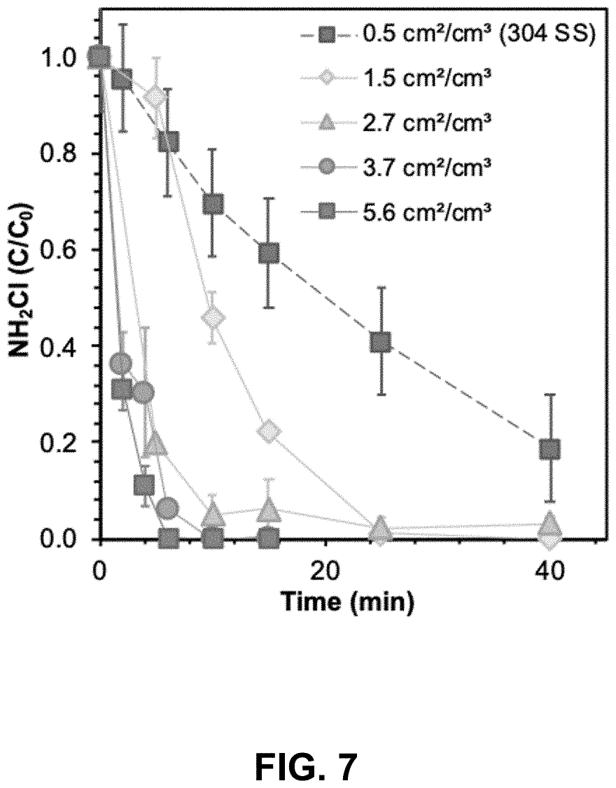

The effect of electrode surface area was analyzed by varying the mass of the 410-grade stainless steel scrubber for the anodes and cathodes, including 1.6 g (128 cm²), 2.9 g (232 cm²), 3.9 g (312 cm²), and 5.9 g (472 cm²) for each electrode. These experiments involved application of −1.17 V/SHE to the cathode without an ion exchange membrane; when normalized to the 85 mL volume of electrolyte, these electrode surface areas corresponded to 1.5 cm²/cm³, 2.7 cm²/cm³, 3.7 cm²/cm³ and 5.6 cm²/cm³. FIG. 7 provides the degradation of 40 μM NH₂Cl over time for these different electrodes together with results for the 304-grade stainless steel plate (39.2 cm² surface area or 0.5 cm²/cm³). The results indicate a significant increase in NH₂Cl degradation with increasing electrode surface area. For surface areas normalized by electrolyte volumes ≥2.7 cm²/cm³, >90% degradation of NH₂Cl was achieved within 10 min.

The choice of electrode material influences a system's electrocatalytic performance. The performance of four grades of stainless steel (201, 304, 410 and 430 grades) was tested as electrodes. These grades differ in their elemental compositions (Table 2). These differences can impact electron transfer, and therefore may affect chloramine reduction rates. Grades 304 and 201 are austenitic stainless steels; both contain high levels of chromium (16-18%), but 304-grade contains ˜8% nickel and ˜2% manganese, while 201-grade contains ˜4% nickel and ˜6.5% manganese. Grade 410 is a martensitic stainless steel with the lowest amount of chromium (11.5-13.5%). Grade 430 is a ferritic stainless steel containing 16-18% chromium but no significant nickel or manganese. The surface areas for each of the stainless steel plate materials (201, 304 and 430 grades) was consistent at 39.2 cm² for each electrode. For the 410-grade stainless steel scrubber electrodes, the surface area for each electrode was 128 cm²; at lower surface areas, the mass of electrode was too small, such that a significant fraction of the total mass of electrode might extend above the electrolyte as samples were removed for analysis.

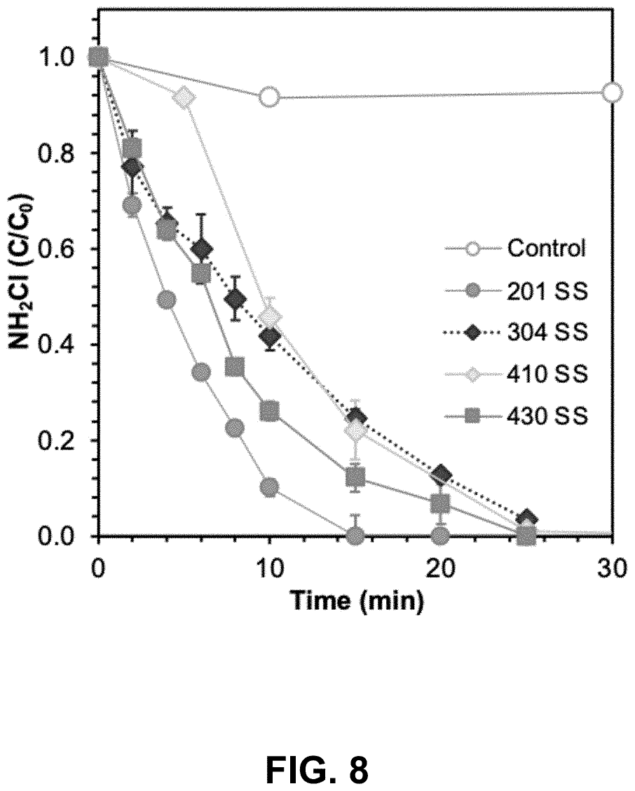

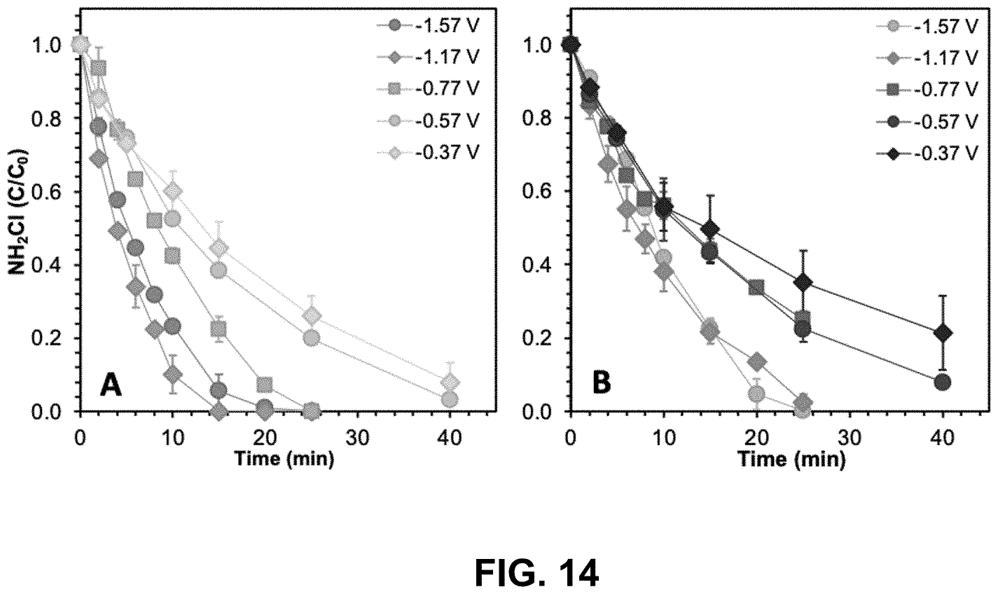

When −1.17 V/SHE was applied to the cathode without an ion exchange membrane, degradation of 40 μM NH₂Cl was fastest for the 201-grade stainless steel electrodes (FIG. 8). The degradation was comparable for the other three grades. When different potentials were applied to 201-grade and 430-grade stainless steel cathodes, chloramine degradation rates increased as the applied potential decreased to −1.17 V/SHE and then leveled out (FIG. 14) in a similar fashion to that observed for the 304-grade stainless steel (FIG. 4B and FIG. 12). However, given the increase in degradation rate with electrode surface area (FIG. 7), these results suggest that the 410-grade stainless steel would exhibit lower reactivity towards NH₂Cl degradation than the 304 and 430 grades of stainless steel since the 410-grade electrodes had an ˜3-fold higher surface area. Notably, the 201-grade featured the highest concentration of manganese, while the nickel concentration was intermediate between the 304 grade and the 410 and 430 grades. The least reactive material (the 410 grade) featured the lowest concentrations of elements (including chromium) other than iron. While these results suggest that manganese may be an important constituent driving the reactivity of stainless steels towards chloramine degradation, future research with stainless steels custom-designed to isolate the importance of different elements within the steel are needed to clarify the role of elemental composition.

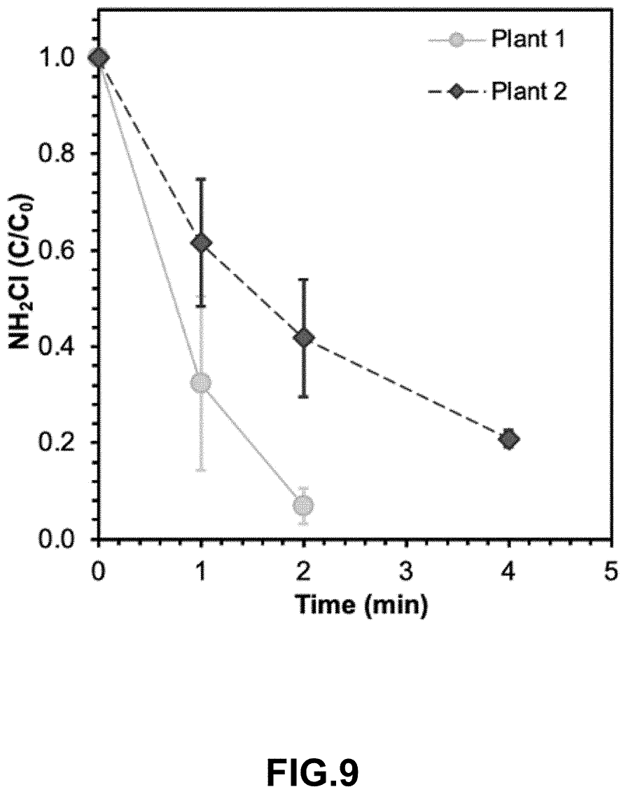

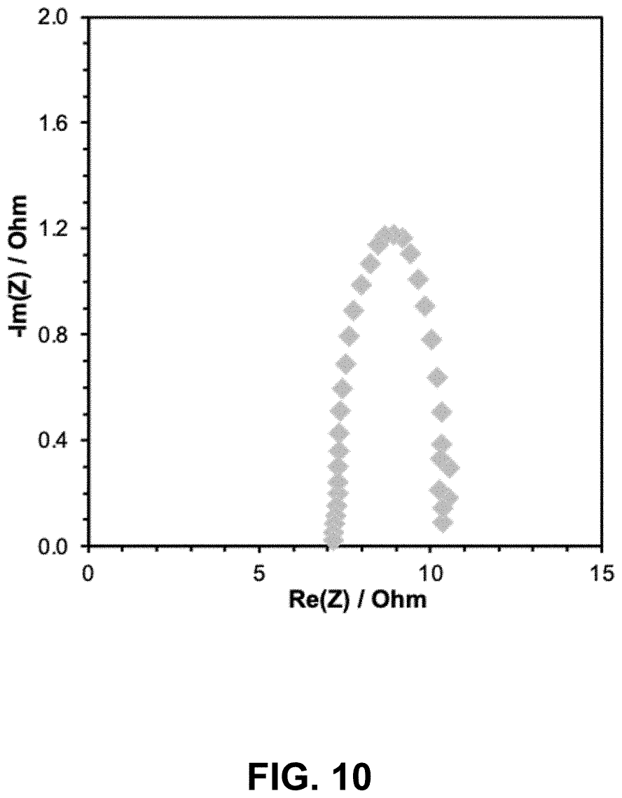

Treatment of authentic chloraminated wastewater effluents: Experiments with two authentic secondary municipal wastewater effluents were conducted under galvanostatic (constant current) conditions to characterize the timescale of the treatment, determine figures of merit (e.g., current efficiency), and to develop initial estimates of the cost for electrical power for comparison to the cost of bisulfite. Galvanostatic operation is a likely mode of operation for treatment in practice. Each effluent was treated using 410-grade stainless steel scrubbers as cathode and anode (3.9 g or 312 cm² each) without an ion exchange membrane with a constant current of 50 mA. Each wastewater effluent was treated four times, with no significant loss of performance noted over the four replicates; FIG. 9 provides the average results across the four replicates.

Treatment of the nitrified effluent (Plant 1; 50 μM NH₂Cl) achieved 68% degradation of chloramines within 1 min and 93% removal within 2 min. Degradation was slower in the non-nitrified effluent (Plant 2; 34 μM NH₂Cl), reaching 79% in 4 min. Regardless, in both cases degradation was achieved over <10 min timescales, a timescale relevant to potential future applications for treating continuous wastewater flows at full-scale treatment facilities. The current density was 0.16 mA/cm² (relative to the surface area of the cathode). Based upon a two-electron transfer to NH₂Cl (equation 2), the current efficiencies were 13% for Plant 1 and 4% for Plant 2. Over the four experimental replicates, the full-cell voltages averaged 3.1 V for Plant 1 and 2.8 V for Plant 2. Electrochemical treatment of Plant 1 water for 2 min would require 0.061 kWh/m³, while treatment of Plant 2 water for 4 min would require 0.11 kWh/m³.

The cost of sodium bisulfite is ˜$0.50/L; based upon the 1:1 stoichiometry required for dechlorination of NH₂Cl (equation 1), the cost to treat 10⁶ L (1 ML) would be $6.54/ML for Plant 1 wastewater (50 μM NH₂Cl) and $4.44/ML for Plant 2 wastewater (34 μM NH₂Cl). It has been reported that the cost utilities in the United States pay for electrical power varies significantly, from $0.062/kWh for one utility in Texas to $0.134/kWh for another utility in California. For $0.062/kWh, treatment of Plant 1 water for 2 min would cost $3.77/ML, less than the cost for dechlorination by bisulfite. However, electrochemical treatment would be more expensive under other scenarios. For example, treatment of Plant 2 water for 4 min would cost $6.81/ML. At $0.134/kWh, the costs for treating the waters would be $8.15/ML for Plant 1 and $14.71/ML for Plant 2. Thus, based on reagent and electricity costs, whether electrochemical dechlorination could be cost-competitive with dechlorination by bisulfite depends strongly on the cost of electrical power and the specific wastewater.

There is limited room for further optimization of dechlorination by bisulfite; however, it is important to note that there is significant room to further optimize the electrochemical treatment system. For example, power costs increase with the full-cell voltage (FCV), which includes the equilibrium potential for the electrochemical reaction (V₀), the overpotentials at the cathode (η_{c}) and anode (ηₐ), and the voltage drop associated with the solution resistance (iRₛₒₗ; equation 13). The solution resistance (Rₛₒₗ) correlates with the ionic resistivity of the electrolyte (p) and the spacing between electrodes (1), and inversely with the planar area of the electrodes (A) (equation 14). The non-planar 410-grade stainless steel scrubbers were used as electrodes for treating the wastewater samples due to their high surface areas, but they were not amenable to optimization of the spacing between the electrodes. When 304-grade stainless steel plates were used as anode and cathode, the full-cell voltage measured under galvanostatic conditions (50 mA) with Plant 2 wastewater declined from 12.4 V to 4.1 V as the spacing of the electrodes decreased from 3 cm to 0.6 cm. This type of optimization of the electrode configuration, together with further optimization of the specific surface area of the stainless steel electrodes (FIG. 7) and their elemental constitution (FIG. 7), could render electrochemical dechlorination more cost-competitive for utilities with higher electricity rates. The avoidance of transportation of bisulfite to water utilities and the associated CO₂ emissions would be additional benefits.

$$FCV = {V}_{0} + {η}_{c} + {η}_{a} + i {R}_{s o l} \qquad ( 13 )$$

$${R}_{s o l} = \frac{ρ l}{A} \qquad ( 14 )$$

TABLE 1
Water Quality Data (mg/L) for Municipal
Wastewater Effluent Samples

| | NO₂—N | NO₃—N | NH₃—N | DOC | UV₂₅₄ | pH |
|---|---|---|---|---|---|---|
| Plant 1 | 0.6 | 12.6 | 1.3 | 8.8 | 0.181 | 7.2 |
| Plant 2 | 0.7 | 0.00 | 47 | 19.9 | 0.307 | 7.3 |

TABLE 2
Concentration (%) of elements within the different stainless-steel types.

| | C | Si | Mn | P | S | Cr | Ni | Cu | Mo | N |
|---|---|---|---|---|---|---|---|---|---|---|
| SS201 | ≤0.15 | ≤0.25 | 5.5-7.5 | ≤0.06 | ≤0.03 | 16-18 | 3.5-5.5 | — | — | — |
| SS304 | 0.02 | 0.3 | 1.78 | 0.03 | 0.002 | 18.1 | 8.03 | 0.47 | 0.41 | 0.07 |
| SS410 | 0.08-0.15 | ≤1.0 | ≤1.0 | ≤0.04 | ≤0.03 | 11.5-13.5 | ≤0.75 | — | — | — |
| SS430 | ≤0.12 | ≤0.75 | ≤1.0 | ≤0.04 | ≤0.03 | 16-18 | ≤0.6 | — | — | — |

What is claimed is:

1. A method of electrochemical dechlorination of water, comprising:
(a) having an electrochemical reactor with a cathode and an anode;
(b) having water in the electrochemical reactor, wherein the water contains chlorine or chloramine; and
(b) dechlorinating the water by passing electrons directly from an electrical grid to the chlorine or the chloramine via the cathode, wherein the dechlorination for the chlorine is defined by HOCl+2e⁻→Cl⁻+OH⁻, and wherein the dechlorination for the chloramine is defined by NH₂Cl+H⁺2e⁻→Cl⁻+NH₃.

2. The method as set forth in claim 1, wherein the cathode is a stainless steel cathode.

3. The method as set forth in claim 1, wherein the cathode and the anode are separated by a cation-exchange membrane.
